(19) United States
(12) Patent Application Publication
(10) Pub. No.: US 2007/0008088 A1
(43) Pub. Date: Jan. 11, 2007

(54) A MULTIPOWER PASSIVE ENTRY FOB

(75) Inventors: John S. Nantz, Brighton, MI (US); Riad Ghabra, Dearborn Heights, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/160,080

(22) Filed: Jun. 8, 2005

(51) Int. Cl. B60R 25/10

(52) U.S. Cl. 340/426.29

(57) ABSTRACT

Method and system of passive entry. The method and system relating to controlling signal power levels. The method and system may include limiting signal power levels so as to limit re-radiation interference.

### BACKGROUND OF THE INVENTION

1. Field of the Invention

The present invention relates to passive entry devices and methods.

2. Background Art

Passive entry devices permit a user to enter a building, vehicle, or other structure in a keyless manner and/or to control operation of a vehicle, device, or other feature in a similarly keyless manner. In some cases, the passive entry device transmits a wireless signal to initiate keyless activities. One object of a passive entry device is to allow the user to perform operations without having to interact with the passive entry device.

The wireless nature of passive entry devices can be problematic if the wireless device is exposed to secondary wireless signal sources, such as other remote keyless entry devices. For example, a vehicle owner may have multiple passive entry or non-passive entry keyless devices. The wireless signals from a first device may energize an RF circuit or other transmitting circuit of the second device. Once energized, the second device may broadcast a wireless signal that may interfere with the wireless signals of the first device. This effect is commonly known as re-radiation.

If the re-radiation is sufficiently great, the interference may jam or otherwise render the wireless signals form the first device temporarily inoperable. This can be problematic to the user, especially if the user is attempting a passive entry.

### SUMMARY OF THE INVENTION

One aspect of the present invention relates to a passive entry unit. The unit may include a passive entry input configured to generate a passive entry signal, at least one user selectable control button configured to generate a control button signal, a transmitter configured to transmit wireless signals, and a controller configured to control transmission of the wireless signals as a function of the passive entry and control button signals.

The unit may include the wireless signals being transmitted at a first power level for wireless signals associated with the passive entry signal and at a second power level for wireless signals associated with the control button signal.

The unit may include the first power level being different from the second power level and/or the first power level being less than the second power level.

The unit may include at least three control buttons, wherein at least one of the control buttons unlocks a vehicle door, unlocks a vehicle trunk, initiates a remote vehicle start, or initiates a panic alarm.

The unit may include the controller issuing signals to control the power level of the wireless signals. For example, the controller may output the signals directly to the transmitter to control the power level and/or it may issue signals to an attenuator circuit to control the power level.

One aspect of the present invention relates to a wireless, passive entry key fob device configured for use with a vehicle. The device may include a passive entry portion to control passive entry to the vehicle and a remote control portion to control operation of at least one vehicle function. The device may include a controller configured to control wireless signals transmitted from the device. The controller may be configured to facilitate transmission of wireless signals associated with passive entry at first power level and to transmit wireless signals associated with remote control at a second power level.

The device may include a re-radiation detector configured to control the wireless signal power levels as function of inputs received by the re-radiation detector.

The controller may be configured to control signal power levels as a function of battery/capacitor life and/or battery/capacitor charge.

One aspect of the present invention relates to a method of limiting interference to a passive entry fob by a secondary RF unit. The method may include configuring the fob to transmit wireless signals at multiple power levels such that wireless signals associated with passive entry are transmitted at a first power level and wireless signals associated with non-passive entry are transmitted at a second power level.

The method may include transmitting signals associated with the first power level at a power less than the second power level so as to limit re-radiation from the secondary RF unit, and thereby, interference with the passive entry fob.

The method may include controlling the wireless signal power levels as a function of inputs received from a re-radiation detector.

The above features and advantages, along with other features and advantages of the present invention, are readily apparent from the following detailed description of the invention when taken in connection with the accompanying drawings.

### BRIEF DESCRIPTION OF THE DRAWINGS

FIG. 1 is a schematic illustration of an entry unit in accordance with one non-limiting aspect of the present invention;

FIG. 2 illustrates the unit including a re-radiation element in accordance with one non-limiting aspect of the present invention; and

FIG. 3 illustrates the unit including an attenuator circuit in accordance with one non-limiting aspect of the present invention.

### DETAILED DESCRIPTION OF THE PREFERRED EMBODIMENT(S)

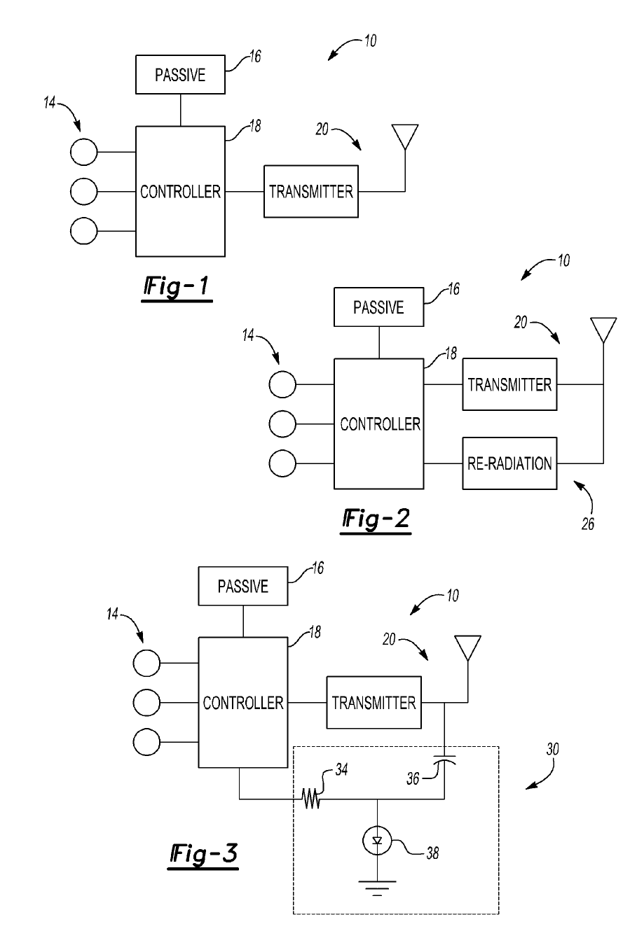

FIG. 1 is a schematic illustration of an entry unit 10 in accordance with one non-limiting aspect of the present invention. The unit 10 may be used to wireless control vehicles, buildings, and other electrically operable items. The unit 10 may include a number of user selectable switches 14, a passive entry element 16, a controller 18, a transmitter 20.

The unit 10 may be a fob or similar device having packaging and dimensioning to facilitate use on a key-chain or other portable items. The fob 10 may include a housing (not shown) of plastic or other durable material. The housing may be used to house some or all of the features shown in FIG. 1 and to provide protection thereto.

The unit 10 may include an energy storage device (not shown) to power the unit. The device may be a battery, capacitor, or other electric energy storage device. The controller 18 and/or the energy storage device may include logic or other features for determining energy available therefrom.

The switches 14 may be push-button, touch-sensitive, or other user selectable features. Selection of the switches 14 may generate a signal or other input to the controller 18. The unit 10 is shown to include three switches but any number of switches may be included. The switches 14 or portions thereof may be exposed or otherwise actuated from an exterior portion of the housing. For example, the housing may include a lever or other feature which may be pressed or touched by the user to actuate the switch.

The transmitter 20 may be used to transmit wireless signals. Optionally, the transmitter 20 may be used to receive wireless signals and to transport the signals to the controller 18. The present invention fully contemplates any number of configurations for transmitting wireless signals with the transmitter 18 or another similar unit and is not intended to be limited to the foregoing.

The transmitter 20 may be configured to support wireless signal generation. It may comprise a radio frequency (RF) circuit configured to generate low frequency (LF) signals. Alternatively, the transmitter may be configured to generate UHF and/or other signals. The present invention fully contemplates any number of configurations for transmitting wireless signals and is not intended to be limited to the foregoing.

The passive entry element 16 may be configured to generate passive entry related inputs to the controller 18. The passive entry element 18 may include an antenna (not shown) or other feature for sensing or determining signals from passive entry units, such as a vehicle, building, etc. The passive entry element 18 may analyze the received signals and output corresponding signals to the controller 18 as a function thereof. The passive entry element is shown as a separate feature, however, the present invention contemplates its integration with the controller 18, such as to leverage off of signals received through the transmitter 20.

The controller 18 may be a microcontroller, programmable logic controller (PLC), or other feature capable of executing logic operations and functions. It may be included within an integrated circuit or printed circuit board and include any number of inputs and outputs.

The controller 18 may be configured to control wireless signals transmitted by the transmitter 20. For example, the controller 18 may output signals to the transmitter 20 for controlling the operation thereof. The transmitter 20 may be controlled to output any number of signals at any number of power levels, as a function of the signals received from the controller 18.

The controller 18 may be configured to cause transmission of one type of wireless signal for a given input and another type of wireless signals for a different input. For example, the inputs associated with the switches 14 may be associated with different remote control commands, depending on the device being controlled. If the devices is a vehicle, the switches may be associated with remote starting, security disarmament (unlock door, trunk, etc.), initiating a panic alarm, and other remote keyless entry (RKE) functions. Different signals may be generated for each of the remote control functions so that a receiver or other feature on the vehicle may control the appropriate vehicle function, system, or subsystem related to executing the operation associated therewith.

Likewise, if the control inputs are from the passive entry portion 16, the controller 18 may select different signals as a function thereof. For example, the passive entry element 16 may determine that a user is approaching a vehicle and generate a corresponding input to the controller 18 for unlocking the vehicle doors. The passive entry element 16 may determine the vehicle to be approaching the vehicle based on signals received from the vehicle and/or it may be configured to automatically transmit passive entry signals, without requiring interaction with the vehicle. Once inside the vehicle, the passive entry element 16 may generate an input to the controller for permitting push-button start of the vehicle.

Of course, the present invention fully contemplates the controller 18 receiving any number inputs and include any number of configuration and features for transmitting wireless signals as a function thereof. As one skilled in the art will appreciate, passive entry units are becoming more and more prevalent and more and more logic is being developed to support any number of operations. Accordingly, the present invention is not intended to be limited to any particular number of inputs or wireless signal generation logic.

The controller 18 may be configured to controllably output signals to the transmitter 20 to control the operation thereof. The transmitter 20 may be correspondingly configured to control signals transmissions according to the signals received from the controller 18. The power levels may be controlled so as to control range, intensity, and other parameters associated with transmitting wireless signals.

The controller 18 may be configured to control signal power levels as a function of the inputs associated with the wireless signals. For example, if the controller 18 receives an input form the passive entry element 16 to generate a passive entry related wireless signal, the wireless signal associated therewith may be emitted at a predefine or programmed power level. Likewise, if the controller 18 receives an input form the switches 14 to generate a remote control related wireless signal, the wireless signal associated therewith may also be emitted at a predefine or programmed power level.

The controller 18 may be programmed or otherwise instructed to emit the wireless signals at the same or different power levels. For example, the controller 18 may be configured to emit the passive entry related signals at a power level which is less than a power level associated with the remote control related signals. This may be advantageous in limiting re-radiation and other interference generating phenomena commonly associated with more powerful signals.

The controller 18 may be configured to emit signals at different power levels as a function of the inputs associated therewith and/or the features intended to be controlled by the inputs. For example, a remote start command may be associated with a greater power level than a remote unlock command, as it may be beneficial to permit users to remotely start the vehicle from longer distance than to unlock the doors. In this manner, different power levels may be assigned to each button or the functions associated therewith.

The controller 18 may be configured to adjust power levels as a function of energy available form the energy storage device. For example, if the battery or other electrical storage unit is low on power, the controller may be configured to limit wireless signal power levels so as to prolong operation of the unit.

FIG. 2 illustrates the unit 10 including a re-radiation element 26 in accordance with one non-limiting aspect of the present invention. The re-radiation element 26 may be separate feature and or it may be integrated within the controller 18 or transmitter 20. It may be configured to assess, measure, or otherwise quantify ambient signal levels or other signals which may interfere with signals emitted from the unit 10.

The re-radiation element 26 may be configured to output signals to the controller 18 as a function its readings. This may be advantageous in preventing jamming and other interference by appropriately controlling the wireless signal power levels. The controller 18 may be configured to adjust signal power levels to compensate for re-radiation caused thereby. For example, the controller 18 may be configured to reduce signal power levels if the re-radiation element 26 detects other signal levels which may interfere with operation of the unit.

FIG. 3 illustrates the unit 10 including an attenuator circuit 30 in accordance with one non-limiting aspect of the present invention. The attenuator circuit 30 may be configured to draw power away from the antenna so as to limit signal power levels. The attenuator circuit 30 is shown to include a resistor 34, capacitor 36, and diode 38, however, any number of features may be included.

The controller 18 may be configured to activate the attenuator circuit 30 to control signal power levels. For example, if passive entry relates signals are desired, the attenuator circuit 30 may be enabled to reduce the signal power levels associated therewith. This may be advantageous, for example, to limit re-radiation from preventing access to or push-button start of a vehicle. The remote control related signals may be limited in a similar fashion.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A passive entry unit, the unit comprising:
a passive entry input configured to generate a passive entry signal;
at least one user selectable control button configured to generate a control button signal;
a transmitter configured to transmit wireless signals; and
a controller configured to control transmission of the wireless signals as a function of the passive entry and control button signals, wherein the wireless signals are transmitted at a first power level for wireless signals associated with the passive entry signal and at a second power level for wireless signals associated with the control button signal.

2. The unit of claim 1 wherein the first power level is different from the second power level.

3. The unit of claim 1 wherein the first power level is less than the second power level.

4. The unit of claim 1 further comprising at least three control buttons, wherein at least one of the control buttons unlocks a vehicle door, unlocks a vehicle trunk, initiates a remote vehicle start, or initiates a panic alarm.

5. The unit of claim 1 wherein the controller issues signals to control the power level of the wireless signals.

6. The unit of claim 5 wherein the controller outputs the signals directly to the transmitter to control the power level.

7. The unit of claim 5 wherein the controller issues signals to an attenuator circuit to control the power level.

8. The unit of claim 7 wherein the controller issues signals to the attenuator circuit to limit power to an antenna associated with the transmitter such that only wireless signals associated with the first power level are transmitted if the attenuator circuit is active.

9. The unit of claim 8 wherein wireless signals associated with the control button signals are transmitted at the first power level instead of the second power level if the attenuator circuit is active.

10. A wireless, passive entry key fob device configured for use with a vehicle, the device including a passive entry portion to control passive entry to the vehicle and a remote control portion to control operation of at least one vehicle function, the device comprising:
a controller configured to control wireless signals transmitted from the device, wherein the controller is configured to facilitate transmission of wireless signals associated with passive entry at first power level and to transmit wireless signals associated with remote control at a second power level.

11. The device of claim 10 wherein the first power level is different from the second power level.

12. The device of claim 10 further comprising a transmitter to transmit the wireless signals.

13. The device of claim 13 wherein the controller issues signals to the transmitter to control the power level of the wireless signals.

14. The device of claim 13 issues signals to an attenuator circuit to control the power level of the wireless signals.

15. The device of claim 15 wherein the attenuator circuit limits power to an antenna associated with the transmitter when active such that only wireless signals associated with the first power level are transmitted if the attenuator circuit is active.

16. The device of claim 16 wherein wireless signals associated with remote control are transmitted at the first power level instead of the second power level if the attenuator circuit is active.

17. The device of claim 10 further comprising a re-radiation detector, wherein the controller is configured to control the wireless signal power levels as function of inputs received by the re-radiation detector.

18. The device of claim 10 wherein the controller is configured to control signal power level as a function of energy available from an energy storage device.

19. A method of limiting interference to a passive entry fob by a secondary RF unit, the method comprising:
configuring the fob to transmit wireless signals at multiple power levels such that wireless signals associated with passive entry are transmitted at a first power level and wireless signals associated with non-passive entry are transmitted at a second power level, the first power level being less than the second power level so as to limit re-radiation from the secondary RF unit, and thereby, interference with the passive entry fob.

20. The method of claim 19 further comprising:
controlling the wireless signal power levels as a function of inputs received from a re-radiation detector.
